(19) United States
(12) Patent Application Publication
(10) Pub. No.: US 2008/0098853 A1
(43) Pub. Date: May 1, 2008

(54) MULTIPLE CONTAINER OPENER

(76) Inventor: Harold F. Choate, Dallas, TX (US)

Correspondence Address: ANDERSON, LEVINE & LINTEL L.L.P., 14785 PRESTON ROAD, SUITE 650, DALLAS, TX, 75254, US

(21) Appl. No.: 11/924,049

(22) Filed: Oct. 25, 2007

Related U.S. Application Data
(60) Provisional application No. 60/863,192, filed on Oct. 27, 2006.
(60) Provisional application No. 60/890,721, filed on Feb. 20, 2007.

(51) Int. Cl. B67B 7/44

(52) U.S. Cl. 81/3.09; 220/703

(57) ABSTRACT

A drinking vessel includes a tab/bottle cap/twist cap opener for aiding in the opening of a beverage can or bottle. For cans, the lip of the tab opener is slid underneath the tab to pry it upwards. A bottle cap opener pries open crown caps and a twist-top opener holds twist-top caps. The tab/bottle cap/twist cap opener can be formed integrally to a drinking vessel, on a bottom plate secured to a drinking vessel, as a stand-alone opener or as part of a novelty item such as a picture frame, coaster, or sports article such as a hockey puck or racing wheel, or a picture frame.

### CROSS-REFERENCE TO RELATED APPLICATIONS

This application claims the benefit of the filing date of co-pending provisional applications U.S. Ser. No. 60/863,192, filed Oct. 27, 2006, entitled “DRINKING VESSEL WITH INTEGRAL OPENER” and U.S. Ser. No. 60/890,721, filed Feb. 20, 2007, entitled “DRINKING VESSEL WITH INTEGRAL OPENER”, which are incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to drinking glasses and, more particularly, to a product with an integrated multi-container opener.

2. Description of the Related Art

A large percentage of beverage containers are of the metal can variety, which are opened using a tab (or “pop-top”). Cans are favored by many people, because they are light weight and unbreakable relative to glass bottles.

Many people, however, do not like opening metal beverage containers with their hands, because it is easy to break a finger nail while inserting it under the tab. Accordingly, a knife or other flat object may be used if available.

Similarly, devices for opening other beverage types (specifically, twist cap bottles and non-twist crown caps) are not always available when needed, and it is generally not aesthetically desirable to have opening devices lying around the house for convenience.

Therefore, a need has arisen for a convenient device to open beverage containers.

### BRIEF SUMMARY OF THE INVENTION

In the present invention, a device for opening multiple container types comprises a material layer having a flat surface and a having slot formed in at least a portion of a side of the material layer for receiving a tab of a flip-top container, such that leverage can be applied to the tab by tilting the material layer. A crown cap opener is formed proximate the flat surface for engaging a lip of a crown cap, such that leverage can be applied to the crown cap by tilting the material layer. An opening formed in the flat surface mates with a twist cap, such that leverage can be applied to the twist cap by rotating the material layer.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIGS. 1a and 1b illustrate side and bottom views of a drinking vessel with an integral tab opener;

FIG. 2 illustrates use of the drinking vessel of FIGS. 1a and 1b to open a can with a tab;

FIGS. 3a and 3b illustrate an alternative embodiment of a drinking vessel with an integral tab opener;

FIG. 4 illustrates a bottom with an integral tab opener for mating with a drinking vessel;

FIGS. 5a and 5b illustrates perspective and top views of an embodiment of a device for opening standard bottle tops, twist-off bottle tops and can tabs;

FIGS. 6a and 6b illustrate the device of FIG. 5a in an embodiment of a bottom plate for securing to the bottom of a glass;

FIG. 6c illustrates the device of FIG. 5a in an embodiment integral to a glass;

FIG. 7a illustrates the device of FIG. 5a in an embodiment for a bottom plate for securing to the bottom of a mug;

FIG. 7b illustrates the device of FIG. 5a in an embodiment for integral to the bottom of a mug;

FIG. 8 illustrates a stand-alone embodiment of the device of FIG. 5a, in the shape of a hockey puck;

FIG. 9 illustrates a stand-alone embodiment of the device of FIG. 5a, in the shape of a racing car tire;

FIG. 10 illustrates a stand-alone embodiment of the device of FIG. 5a, for use as a coaster;

FIG. 11 illustrates a stand-alone embodiment of the device of FIG. 5a, for use as a picture frame/paperweight.

### DETAILED DESCRIPTION OF THE INVENTION

The present invention is best understood in relation to FIGS. 1-11 of the drawings, like numerals being used for like elements of the various drawings.

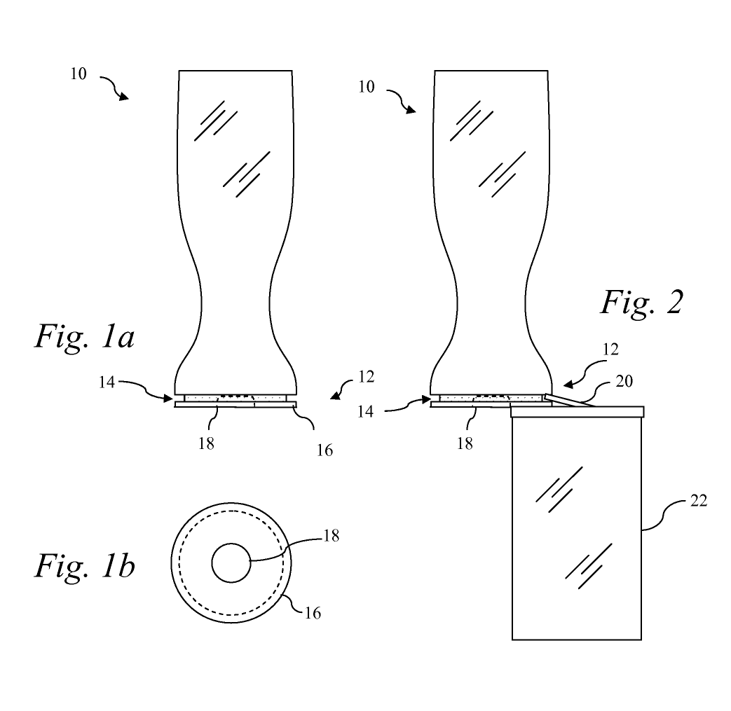

FIGS. 1a and 1b illustrate side and bottom views of a drinking vessel 10 with an integral tab opener 12. In the embodiment shown in FIGS. 1a and 1b, the tab opener 12 includes channel 14 forming a lip 16 around the bottom of the vessel 10, wherein the lip 16 can be slid underneath a tab (see FIG. 2) to assist in opening a can.

In the illustrated embodiment, the vessel 10 is shown as a Weiss-type glass; however, any type of vessel could incorporate the integral tab opener 12, including, for example, mugs and the beverage cans themselves.

In addition to the tab opener 12, vessel 10 optionally includes a twist top opener 18. Twist top opener 18 mates with twist off bottle caps. In operation, the cap is inserted into opener 18 which engages with the teeth of the cap while the bottle or the vessel is twisted.

FIG. 2 illustrates operation of the tab opener 12. The lip 16 is inserted under the tab 20 of a can 22. By tilting the vessel 10 or the can 22, leverage is applied to the tab 20 causing the tab to depress a pre-scored area on the top of the can 22 beneath the tab, such that the pre-scored area splits from the top of the can when pressed by the tab 20.

The present invention allows the user to easily open a can without using his or her fingers to pry open the tab. This is especially useful for restaurant and bar personnel who can open the can with the vessel into which the liquid will be poured.

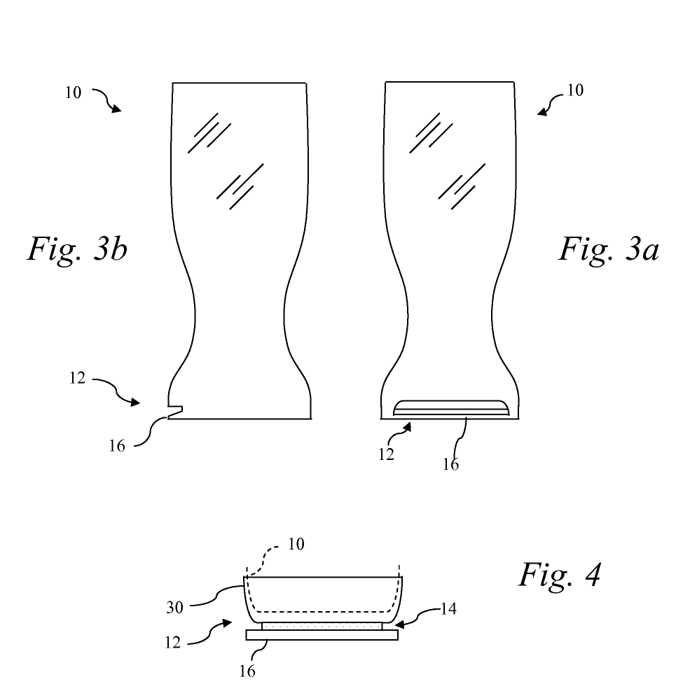

FIGS. 3a and 3b illustrate front and side views, respectively, of an alternative embodiment where the lip 16 is formed from a sector of the bottom of the vessel 10, rather than about the entire periphery of the vessel.

FIG. 4 illustrates an embodiment of the invention wherein the lip 16 is formed in a bottom plate 30 which can be applied to an existing glass design. This reduces the cost of providing the tab opening feature. The bottom plate could be made in a variety of different designs, for example with different team logos, and applied to vessel 10 with a mating bottom section. The bottom plate 30 could be made with other lip designs, such as the type shown in FIGS. 3a and 3b.

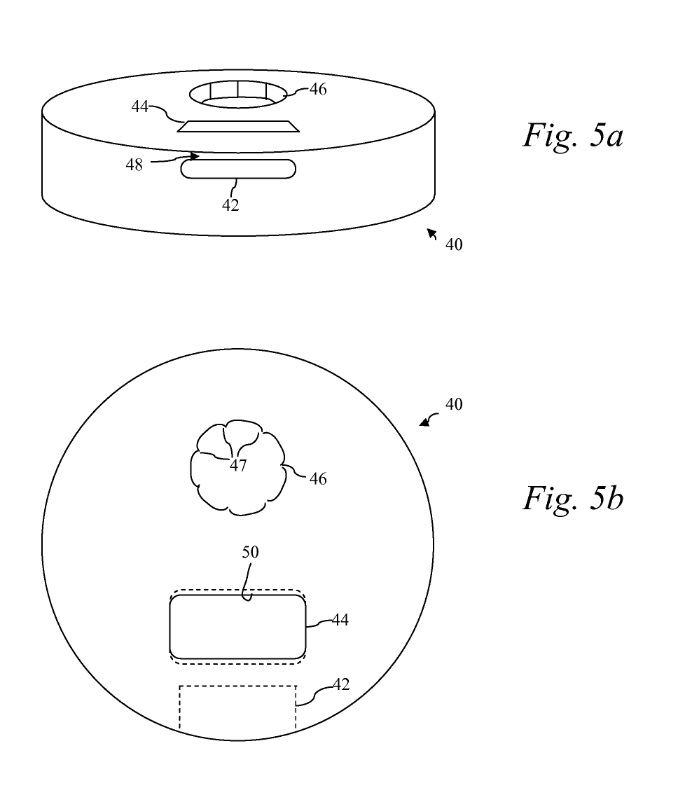

FIGS. 5a and 5b illustrate the perspective and top views of an embodiment for a combination tab opener/bottle opener/twist top opener (hereinafter the “multi-top opener”). The multi-top opener 40 includes a slot 42 for opening can tabs, a bottle opener 44 for prying bottle caps off bottles using leverage and a twist-top opener 46 for engaging a twist-off bottle cap to aid in twisting the bottle relative to the cap.

The tab opener 42 has a narrow surface 48 which easily slips under a can tab. By tilting the multi-opening device 40 relative to the can, the tab engages and opens the pre-scored area of the top of the can.

The bottle opener 44 has edges 50 which engage under the lip of a bottle cap. When leverage is applied, the other side of the bottle opener holds down the upper surface of a bottle cap while the engaged edge 50 pulls upwardly on an edge of the bottle cap, thus prying the cap off.

The twist-top opener 46 mates with a twist-off bottle top, as described above in connection with FIGS. 1-4. Ridges 47 may be used to interface with the teeth of a crown cap; typically, three or seven ridges are used to conform to 21 or 24 teeth of a standard crown cap. Additionally, the twist top opener 44 may be tapered to provide a friction fit with other types of bottles, such as plastic or thin metal twist off caps used on soda bottles or bottled water bottles.

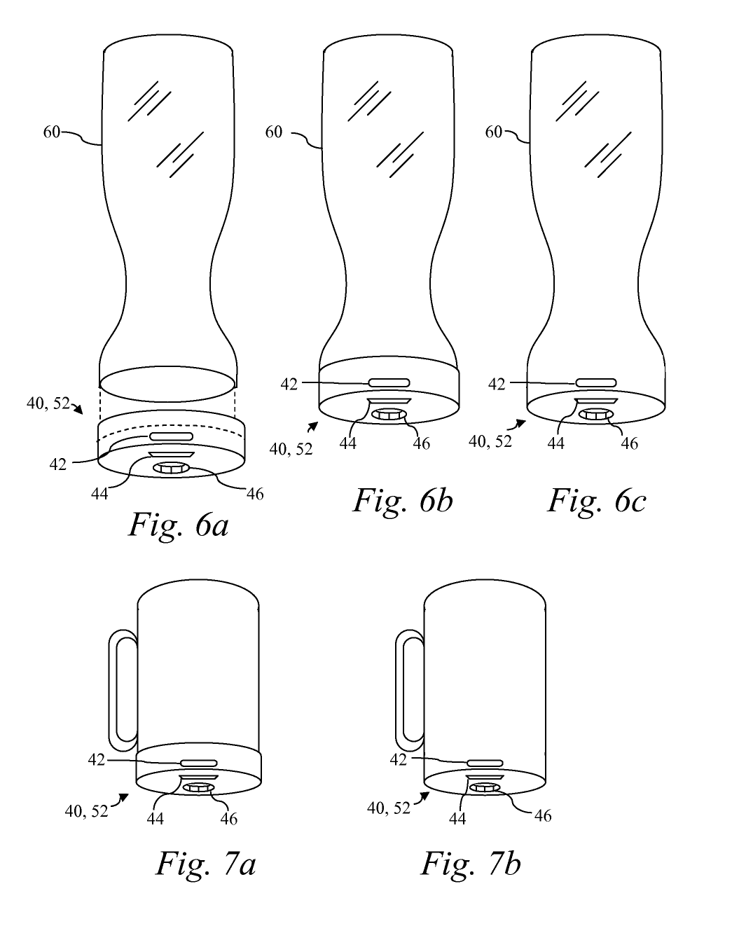

FIGS. 6a and 6b illustrates a bottom plate 52 incorporating the multi-opening device 40, which may be secured to the bottom of a drinking vessel 60 to provide the multi-opening capabilities discussed above using the drinking vessel itself. FIG. 6a illustrates an exploded view of the drinking vessel 60 and bottom plate 52, while FIG. 6b illustrates the two components together. FIG. 6c illustrates a drinking vessel having the multi-opening device 40 integrated into the drinking vessel 60.

FIGS. 7a and 7b correspond to FIGS. 6b and 6c, with the exception that a mug is used as the drinking vessel.

It should be noted that the multi-opening device 40 can be used with any type of drinking vessel, including any shape of drinking vessel, and any material, such as glass, acrylic, plastic, metal, or ceramic. If the material of the drinking vessel is too fragile to use for the features described above, a sturdier bottom plate can be used, as shown in FIGS. 6a-b and 7a.

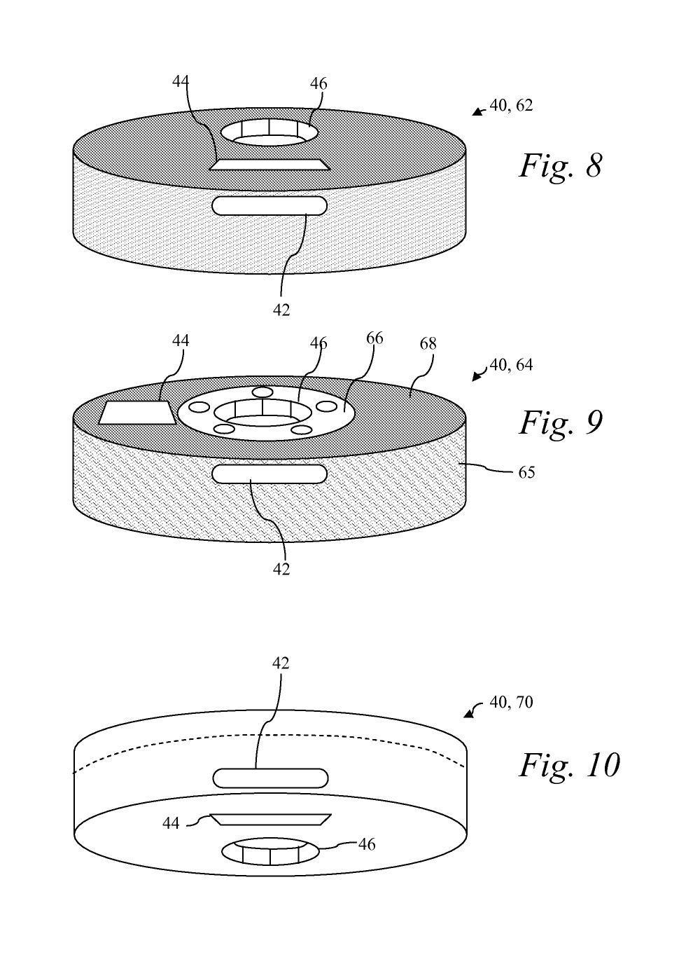

FIG. 8 illustrates an embodiment of the multi-opening device 40 in the shape of a hockey puck 62. In this embodiment, the hockey puck 62 could be a stand-alone bottle/can opener, or secured to a drinking vessel. Logos and/or names could be applied to the puck 62.

FIG. 9 illustrates an embodiment of the multi-opening device 40 in the shape of a racing car tire/wheel 64 with a tread pattern on the outer wall 65 and a design around the twist-top opener 46 similar to that of a racing wheel 66. As before, the tire/wheel 64 could be a stand-alone bottle/can opener, or secured to a drinking vessel. Logos and/names could be applied to the tire 68.

Other representations of sporting articles which could incorporate the multi-opening device would include, but not be limited to footballs, baseballs, and basketballs.

FIG. 10 illustrates an embodiment of the multi-opening device 40 for use as a coaster 70. The top of coaster could be made of various materials typically used for coasters, such as cork or plastic.

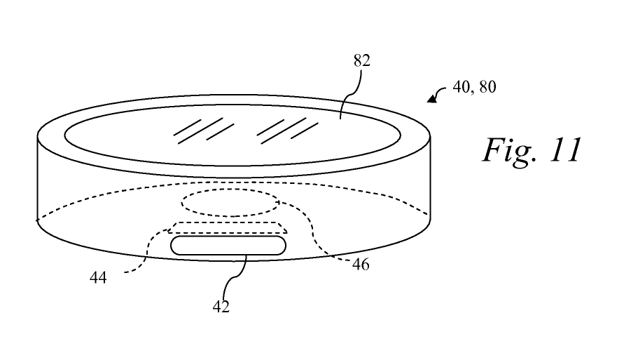

FIG. 11 illustrates an embodiment of the multi-opening device 40 for use as a picture frame (or paper weight) 80 which could be placed on a table. A picture could be removably placed under a transparent layer 82, or the picture could be applied to the multi-opening device 40.

The multi-opening device could be incorporated into other novelty items as well as those shown herein.

The present invention provides significant advantages over prior opening devices. First, it is easily incorporated into a drinking vessel to open the three most popular container types. Second, the three openers can be formed in a material layer with a flat bottom in a way that the device can be placed on a table. This allows the device to be incorporated in an unobtrusive manner into a number of products, such as drinking vessels, coasters, picture frames, and novelty items, that can be placed on a table without the damaging the table. When the product is on the table, the functionality of the device is hidden. Thus, it is possible to have a number of opening devices available, while the opening devices are generally hidden from view by the object itself. A pad can be placed on the bottom of the device, with cut-outs for the twist-top opener 46 and the crown cap opener 44 to protect furniture.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A device for opening multiple container types, comprising:
a material layer having a flat surface and a having slot formed in at least a portion of a side of the material for receiving a tab of a flip-top container, such that leverage can be applied to the tab by tilting the material layer;
a crown cap opener formed proximate the flat surface for engaging a lip of a crown cap, such that leverage can be applied to the crown cap by tilting the material layer; and
an opening formed in the flat surface for mating with a twist cap, such that leverage can be applied to the twist cap by rotating the material layer.

2. The device of claim 1 wherein the material layer is a bottom portion of a drinking vessel.

3. The device of claim 1 wherein material layer is a bottom for application to drinking vessel.

4. The device of claim 1 wherein the material layer is shaped to represent a sporting article.

5. The device of claim 4 wherein the material layer is shaped to represent a hockey puck.

6. The device of claim 4 wherein the material layer is shaped to represent one of a basketball, football or baseball.

7. The device of claim 4 wherein the material layer is shaped to represent a race car tire.

8. The device of claim 1 wherein the material layer is part of a coaster.

9. The device of claim 1 wherein the material layer is part of a picture frame.

10. The device of claim 1 wherein a pad may be applied to the material layer to provide protection while the device is set on a flat surface.

11. A drinking vessel comprising:
a containing portion for holding a beverage; and
a device for opening multiple container types, comprising:
a material layer having a flat surface and a having slot formed in at least a portion of a side of the material for receiving a tab of a flip-top container, such that leverage can be applied to the tab by tilting the material layer;
a crown cap opener formed proximate the flat surface for engaging a lip of a crown cap, such that leverage can be applied to the crown cap by tilting the material layer; and
an opening formed in the flat surface for mating with a twist cap, such that leverage can be applied to the twist cap by rotating the material layer.

12. The drinking vessel of claim 11 wherein the device is attached to the bottom of the containing portion.

13. The drinking vessel of claim 11 wherein the material layer is integral to the containing portion.
